(19) United States
(12) Patent Application Publication
(10) Pub. No.: US 2026/0127755 A1
(43) Pub. Date: May 7, 2026

(54) METHOD AND APPARATUS FOR ESTIMATING DEPTH OF MOVING OBJECT, ELECTRONIC DEVICE, AND STORAGE MEDIUM

(71) Applicant: Beijing Zitiao Network Technology Co., Ltd., Beijing (CN)

(72) Inventors: Jiawei WEN, Beijing (CN); Xiaodong SONG, Beijing (CN); Hengkai GUO, Beijing (CN)

(21) Appl. No.: 19/114,375

(22) PCT Filed: Aug. 24, 2023
(86) PCT No.: PCT/CN2023/114570

§ 371 Date: Mar. 21, 2025

(30) Foreign Application Priority Data
Sep. 22, 2022 (CN) 202211160924.9

(51) Int. Cl. G06T 7/579

(52) U.S. Cl. CPC G06T 7/579; G06T 2207/10016; G06T 2207/10028

(57) ABSTRACT

Disclosed are a method and apparatus for estimating a depth of a moving object, an electronic device, and a storage medium. The method for estimating a depth of a moving object includes: determining a video processing type; determining a target processing mode for estimating the depth of the moving object based on the video processing type; and determining an estimated depth value of the moving object in a to-be-processed video frame based on the target processing mode.

### CROSS-REFERENCE TO RELATED APPLICATION(S)

The disclosure claims the priority to Chinese Patent Application No. 202211160924.9, filed with the Chinese Patent Office on Sep. 22, 2022, which is incorporated herein by reference in its entirety.

### FIELD

The disclosure relates to the technical field of image processing, for example, to a method and apparatus for estimating a depth of a moving object, an electronic device, and a storage medium.

### BACKGROUND

With the development of computer vision technology, a simultaneous localization and mapping (SLAM) algorithm has been applied in a wide range of fields such as augmented reality, virtual reality, autonomous driving, and localization and navigation of robots or unmanned aerial vehicles.

In the related art, by inputting an image into an SLAM system, and extracting scenario depth information from the image by means of the SLAM system, a depth of an object in the image is estimated based on the scenario depth information. However, such a method for estimating a depth is applicable to static objects only, and can hardly effectively estimate depths of dynamic objects in a video.

### SUMMARY

The disclosure provides a method and apparatus for estimating a depth of a moving object, an electronic device, and a storage medium, to realize the effect of accurately estimating depth information of a moving object in a video.

In a first aspect, the disclosure provides a method for estimating a depth of a moving object. The method includes: determining a video processing type: determining a target processing mode for estimating the depth of the moving object based on the video processing type; and determining an estimated depth value of the moving object in a to-be-processed video frame based on the target processing mode.

In a second aspect, the disclosure further provides an apparatus for estimating a depth of a moving object. The apparatus includes: a video processing type determination module configured to determine a video processing type: a target processing mode determination module configured to determine a target processing mode for estimating the depth of the moving object based on the video processing type; and an estimated depth value determination module configured to determine an estimated depth value of the moving object in a to-be-processed video frame based on the target processing mode.

In a third aspect, the disclosure further provides an electronic device. The electronic device includes: one or more processors; and a storage apparatus configured to store one or more programs which, when executed by the one or more processors, causes the one or more processors to implement the above method for estimating a depth of a moving object.

In a fourth aspect, the disclosure further provides a storage medium. The storage medium includes a computer-executable instruction which is configured to, when executed by a computer processor, execute the above method for estimating a depth of a moving object.

In a fifth aspect, the disclosure further provides a computer program product. The computer program product includes a computer program carried on a non-transitory computer-readable medium, where the computer program includes a program code configured to execute the above method for estimating a depth of a moving object.

### BRIEF DESCRIPTION OF THE DRAWINGS

FIG. 1 is a schematic flowchart of a method for estimating a depth of a moving object according to an embodiment of the disclosure;

FIG. 2 is a schematic flowchart of another method for estimating a depth of a moving object according to an embodiment of the disclosure:

FIG. 3 is a schematic structural diagram of an apparatus for estimating a depth of a moving object according to an embodiment of the disclosure; and

FIG. 4 is a schematic structural diagram of an electronic device according to an embodiment of the disclosure.

### DETAILED DESCRIPTION OF EMBODIMENTS

Embodiments of the disclosure will be described below in conjunction with the accompanying drawings. Although some embodiments of the disclosure are shown in the accompanying drawings, the disclosure can be implemented in various forms, and these embodiments are provided to understand the disclosure. The accompanying drawings and the embodiments of the disclosure are merely illustrative.

Various steps described in a method embodiment of the disclosure can be executed in different orders and/or in parallel. In addition, the method embodiment can include additional steps and/or will not execute the steps shown. The scope of the disclosure is not limited in this respect.

The terms “comprise”, “include”, and their variations used herein indicate open-ended inclusions, i.e. “comprise, but is not limited to” and “include, but is not limited to”. The term “based on” means “at least partially based on”. The term “an embodiment” indicates “at least one embodiment”. The term “another embodiment” indicates “at least one further embodiment”. The term “some embodiments” indicates “at least some embodiments”. The definitions relevant to other terms are set forth in the description below.

The concepts “first”, “second”, etc. mentioned in the disclosure are merely used to distinguish between different apparatuses, modules, or units, instead of defining an order or interdependence relation of functions executed by the apparatuses, modules, or units.

The modifiers “a”, “an”, and “a plurality of” mentioned in the disclosure are illustrative rather than restrictive. Those skilled in the art should understand that these modifiers should be interpreted as “one or more” unless clearly indicated otherwise in the context.

The name of a message or information interacting between a plurality of apparatuses in the embodiments of the disclosure is merely descriptive, and is not intended to limit the scope of the message or information.

Before the technical solutions disclosed in the embodiments of the disclosure are used, a user should be notified of a type, use scope, use scenario, etc. of personal information involved in the disclosure in an appropriate manner according to relevant laws and regulations, and authorization from the user should also be acquired.

For example, in response to receiving an active request from the user, prompt information is transmitted to the user, to explicitly prompt the user that a to-be-executed operation requested by the user will require acquisition and use of the personal information of the user. Therefore, based on the prompt information, the user can autonomously select whether to provide the personal information for software or hardware, such as an electronic device, an application, a server, and a storage medium, which executes operations of the technical solutions of the disclosure.

As an embodiment, in response to receiving an active request from the user, the prompt information may be transmitted to the user through a pop-up window. For example, the prompt information may be presented in the pop-up window in a form of text. In addition, the pop-up window may also carry a selection control for the user to select whether to “agree” or “disagree” to provide the personal information for the electronic device.

The above notification and user authorization acquisition processes are merely illustrative, and do not limit the embodiments of the disclosure. Other methods satisfying the relevant laws and regulations can also be applied to the embodiments of the disclosure.

The data (including data itself, and acquisition or use of data) involved in the technical solution should comply with the requirements in corresponding laws and regulations and relevant provisions.

Before the technical solution is introduced, an application scenario may be illustratively described first. Illustratively, after a user captures a video through a capturing apparatus of a mobile terminal, and uploads the captured video to a system based on a simultaneous localization and mapping (SLAM) algorithm, and alternatively; after a user selects a target video from a database, and actively uploads the video to a system based on an SLAM algorithm, the system may parse scenario depth information in the video, to estimate depth information of an object included in a video frame based on the scenario depth information. However, a current method for estimating depth information can estimate depth information of a static object in the video frame only, and cannot accurately estimate a depth of a dynamic object in the video frame. In this case, based on the solution in the embodiment of the disclosure, the depth information of the moving object in the video frame may be estimated based on the scenario depth information and three-dimensional spatial information provided by the SLAM system. Therefore, the effect of accurately estimating the depth information of the dynamic object in the video frame is realized.

FIG. 1 is a schematic flowchart of a method for estimating a depth of a moving object according to an embodiment of the disclosure. The embodiment of the disclosure is applicable to a case that the depth information of the moving object in the video frame is estimated. The method may be executed by an apparatus for estimating a depth of a moving object. The apparatus may be implemented in a form of software and/or hardware, such as an electronic device. The electronic device may be a mobile terminal, a personal computer (PC) terminal or a server, etc.

As shown in FIG. 1, the method includes the following steps.

At S110, a video processing type is determined.

In the embodiment, the apparatus for executing the method for estimating a depth of a moving object according to the embodiment of the disclosure may be integrated in application software supporting an effect video processing function. The software may be installed in the electronic device, such as the mobile terminal and the PC terminal. The application software may be a type of software for image/video processing, and will not be repeated herein, as long as image/video processing can be implemented. It may also be a specially-developed application used for adding effects and displaying effects in software, or integrated in a corresponding interface. The user may process an effect video via the integrated interface in the PC terminal.

The technical solution in the embodiment may be executed in a process of real-time capturing based on the mobile terminal, or executed after the system receives video data uploaded by the user actively. Moreover, the solution in the embodiment of the disclosure may be applied to various application scenarios such as augmented reality (AR), virtual reality (VR), and automatic driving.

In the embodiment, the video processing type may be a video processing mode determined based on a mode for the user to upload a to-be-processed video. The video processing type includes a real-time processing type and a post-processing type. In practical application, in a case that the to-be-processed video is captured by the user in real time based on the capturing apparatus of the mobile terminal, and a depth of a moving object included in the to-be-processed video is estimated based on the mobile terminal, the video processing type of a current to-be-processed video may be determined as the real-time processing type. In a case that the to-be-processed video is a video that has been captured and uploaded to the system by the user actively, and a depth of a moving object included in the to-be-processed video received is estimated, the video processing type of the to-be-processed video may be the post-processing type.

In the embodiment, in a case that the video data received by the system are captured in real time based on the capturing apparatus of the mobile terminal, the video processing type may be determined as the real-time processing type. In a case that the video data are complete video data that have been captured when being received by the system, the video processing type may be determined as the post-processing type. Such an arrangement is advantageous in that the diversity of the mode for estimating the depth of the moving object can be enhanced, so that the depth of the moving object in the to-be-processed video frame can be estimated in real time based on the mobile terminal, and the depth of the moving object in a complete video can also be estimated. Accordingly, the diversity of video processing is improved, and personalized demands of users are satisfied.

At S120, a target processing mode for estimating the depth of the moving object is determined based on the video processing type.

In the embodiment, when it is detected that the user triggers an effect operation, the capturing apparatus of the mobile terminal may be real-time user-oriented to collect the to-be-processed video, and parse the to-be-processed video based on a pre-written program, to obtain a plurality of to-be-processed video frames. In this case, the video processing type may be determined as the real-time processing type. Correspondingly, the to-be-processed video frames may include the moving object. The moving object may be any object whose post or position information changes framed in the video, such as the user and an animal.

A depth estimation may be a sub-task in the field of computer vision, with the objective of acquiring a distance between the object and a capturing point, to provide depth information for a series of tasks such as three-dimensional reconstruction, distance perception, SLAM, a visual mileage estimation, video frame interpolation, and image reconstruction. The depth information of the moving object may be a distance between a pixel point corresponding to the moving object and a capturing point in the finally-presented frame, and may be indicated by a position coordinate of the pixel point in a camera coordinate system.

In the embodiment, in a case of determining the video processing type as the real-time processing type, the target processing mode for estimating the depth of the moving object in the video frame may be determined as a depth mean estimation mode corresponding to the real-time processing type. The depth mean estimation mode may be to determine depth values of some pixel points associated with the moving object, these depth values are averaged, and a finally-obtained depth average value is taken as the depth information of the moving object.

At S130, an estimated depth value of the moving object in the to-be-processed video frame is determined based on the target processing mode.

In the embodiment, the user may capture a video of the moving object in real time based on the capturing apparatus of the mobile terminal, and upload the video to the mobile terminal in real time. Therefore, the video captured in real time and acquired by the system is the to-be-processed video. The plurality of to-be-processed video frames may be obtained by parsing the to-be-processed video based on the pre-written program. The estimated depth value may be a distance between at least one pixel point corresponding to the moving object and the capturing point, or a coordinate value of at least one pixel point corresponding to the moving object in the camera coordinate system.

In the embodiment, the target processing mode may be the depth mean estimation mode. In a case of determining the estimated depth value of the moving object based on the target processing mode, target pixel points satisfying a depth mean estimation condition in the moving object may be determined first, and then the depth average value may be determined based on depth values of these target pixel points. Therefore, a finally-obtained depth average value may be taken as the estimated depth value of the moving object.

Determining the estimated depth value of the moving object in the to-be-processed video frame based on the target processing mode may include that: a capturing parameter corresponding to the to-be-processed video frame and a pixel point parameter of the moving object are determined: a target pixel point is determined based on the capturing parameter, the pixel point parameter, and a constraint condition; and the estimated depth value of the moving object is determined based on point cloud data of the target pixel point.

In the embodiment, the capturing parameter may be a camera pose parameter generated after a pose of the to-be-processed video frame is optimized. Camera position information and rotation information may be acquired based on a gyroscope and an inertial measurement unit in the capturing apparatus corresponding to the to-be-processed video frame. An initial pose of the to-be-processed video frame is determined based on the camera position information and rotation information. The initial pose is optimized based on a bundle adjustment (BA) method. An optimized pose is taken as the capturing parameter corresponding to the to-be-processed video frame. Such an arrangement is advantageous in that a high BA speed may be provided for the simultaneous localization and mapping system, so as to ensure the real-time processing for the video frame by the system. The pixel point parameter may be a pixel coordinate of at least one pixel point used to constitute the moving object in the to-be-processed video frame. In a case of capturing the moving object to obtain the plurality of to-be-processed video frames, the to-be-processed video frames may include a scenario where the moving object is positioned in addition to the moving object. Therefore, in a case of determining the pixel point parameter of the moving object, a mask image of the moving object may be determined first, so that the pixel coordinate of at least one pixel point constituting the moving object may be determined based on the mask image.

In the embodiment, the constraint condition may be a spatial geometric information constraint condition. In other words, in a case of observing a pixel point at a specific position, whether a state of the pixel point corresponds to the specific position is determined. In a case that the state of the pixel point corresponds to the observing position thereof, the pixel point may be determined as satisfying the constraint condition. In a case that the state of the pixel point does not correspond to the observing position thereof, the pixel point may be determined as not satisfying the constraint condition.

In the embodiment, after the to-be-processed video frame are obtained, an initial pose of the to-be-processed video frame may be determined based on a parameter of a sensor of the capturing apparatus corresponding to the to-be-processed video frame. Then, the initial pose is optimized based on a pose optimization method. The optimized pose is taken as the capturing parameter corresponding to the to-be-processed video frame. Meanwhile, the pixel point coordinate of the moving object in the to-be-processed video frame is determined as the pixel point parameter. The target pixel point is determined based on the capturing parameter, the pixel point parameter, and the constraint condition. Therefore, the estimated depth value of the moving object may be determined based on the point cloud data of the target pixel point. Such an arrangement is advantageous in that a plurality of pixel points of the moving object may be divided into dynamic pixel points and static pixel points based on the constraint condition, and the dynamic pixel points may be filtered out as tracking pixel points of the moving object. Therefore, an accuracy rate of the estimated depth value of the moving object is increased, and the localization effect of the moving object in the to-be-processed video frame is improved.

In practical application, the initial pose of the to-be-processed video frame may be determined first. The initial pose is optimized based on the pose optimization method, to obtain the capturing parameter corresponding to the to-be-processed video frame. Meanwhile, the pixel coordinate of at least one pixel point corresponding to the moving object is determined, to obtain the pixel point parameter. The pixel points satisfying the constraint condition among the plurality of pixel points corresponding to the moving object are determined based on the capturing parameter, the pixel point parameter, and the constraint condition. These pixel points are taken as the target pixel points.

Determining the target pixel point based on the capturing parameter, the pixel point parameter, and the constraint condition includes that: triangulation processing is performed on the capturing parameter and the pixel point parameter, to obtain point cloud data corresponding to the pixel point parameter; a backprojection pixel parameter is determined based on the point cloud data and the constraint condition; and the target pixel point is determined based on the pixel point parameter and the backprojection pixel parameter.

In the embodiment, the triangulation processing may be to determine corresponding point cloud data based on a corner detection algorithm. The corner detection algorithm may be a KLT corner detection method, also known as a KLT optical flow tracking method. Based on the KLT corner detection method, a reference key frame suitable for tracking is determined from a plurality of key frames; and a feature point of the reference key frame is determined, to determine the corresponding point cloud data (PCD) based on the feature point. The point cloud data, which is a type of data recorded in a form of points, are generally used in reverse engineering. These points may indicate coordinates in a three-dimensional space, as well as information on color or illumination intensity and the like. In practical application, the point cloud data generally include point coordinate precision, a spatial resolution, a surface normal vector, etc., and are generally stored in a PCD format. In this format, the point cloud data have strong operability, and a speed of point cloud registration and fusion can be improved in a subsequent process, which will not be repeated in the embodiment of the disclosure.

In practical applications, after the capturing parameter and the pixel point parameter being determined, the triangulation processing may be performed on the capturing parameter and the pixel point parameter based on the corner detection algorithm, to obtain three-dimensional point cloud data corresponding to the pixel point parameter. Based on the point cloud data and the constraint condition, parameters of the point cloud data in the camera coordinate system are determined. In other words, three-dimensional point cloud data are converted into a form of two-dimensional coordinates, and two-dimensional coordinate parameters obtained through converting may be taken as the backprojection pixel parameters. The point cloud data are determined based on the pixel point parameter, the backprojection pixel parameter is determined based on the point cloud data, and the pixel point parameter and the backprojection pixel parameter are two-dimensional coordinate parameters. Therefore, the target pixel point may be determined by determining whether the pixel point parameter is consistent with the corresponding backprojection pixel parameter. In other words, a pixel point whose pixel point parameter is inconsistent with the corresponding backprojection pixel parameter is taken as the target pixel point. The pixel point of the moving object is determined based on the mask image. In practical application, a model deployed in the mobile terminal is generally employed to process the to-be-processed video frame, to obtain the mask image corresponding to the moving object. Generally, in order to improve processing efficiency of the mobile terminal, and reduce a memory occupation rate of the model in the mobile terminal, the model deployed in the mobile terminal is generally a model having a simple model structure and a high processing speed. In a case of applying the model to perform mask image processing on the moving object in the to-be-processed video frame, a size of the mask image obtained may be greater than an actual size of the moving object, so that static background points that do not belong to the moving object are also divided into the moving object. Static pixel points may generally satisfy the constraint condition, and dynamic pixel points may not satisfy the constraint condition. Therefore, the dynamic pixel points may be distinguished from the static pixel points by determining whether the pixel points corresponding to the moving object satisfy the constraint condition, so that different processing modes may be employed for different pixel points, and the estimated depth value of the moving object may be obtained finally. Such an arrangement is advantageous in that the pixel points of the moving object can be determined more precisely, and different processing modes can be employed for different pixel points, so that the accuracy rate of the estimated depth value of the moving object can be increased.

Illustratively, determining the backprojection pixel parameter based on the point cloud data and the constraint condition may be determined based on the formula as follows:

$${s}_{i} [ \begin{matrix}{u}_{i} \\ {v}_{i} \\ 1\end{matrix} ] = K exp ( {ξ}^{∧} ) [ \begin{matrix}{X}_{i} \\ {Y}_{i} \\ {Z}_{i} \\ 1\end{matrix} ]$$

sᵢ may indicate a depth value of any pixel point, (uᵢ, vᵢ) may indicate a pixel coordinate of any pixel point, K may indicate a camera internal parameter, exp (ξ\hat{ }) may indicate a camera pose, i.e. an R and T matrix, and (Xᵢ, Yᵢ, Zᵢ) may indicate a three-dimensional point cloud coordinate of any pixel point.

After the target pixel point is determined, the estimated depth value of the moving object may be determined based on the point cloud data of the target pixel point.

Determining the estimated depth value of the moving object based on point cloud data of the target pixel point includes that: at least two to-be-used video frames to which the target pixel point belongs are determined based on the point cloud data of the target pixel point; and the estimated depth value of the moving object is determined based on depth values of the target pixel point in the at least two to-be-used video frames.

In the embodiment, after the target pixel points being acquired, the triangulation processing may be performed on these target pixel points, to obtain the point cloud data corresponding to the target pixel points. The point cloud data may be observed from the plurality of to-be-processed video frames including the moving object, and at least two to-be-processed video frames from which the point cloud data may be observed may be taken as the to-be-used video frames.

In practical application, after the at least two to-be-used video frames to which the target pixel points belong are determined, the depth values of the target pixel points in the camera coordinate system may be determined and averaged, and a finally-obtained depth average value may be taken as the estimated depth value of the moving object. Such an arrangement is advantageous in that the depth information of the moving object can be roughly estimated at the mobile terminal, and the efficiency of estimating the depth of the moving object can be improved.

In a case that the moving object is in a stationary state, a plurality of pixel points of the moving object determined based on the mask image satisfy the constraint condition. In other words, pixel point parameters of the plurality of pixel points are consistent with the backprojection pixel parameter. In this case, the triangulation processing may be performed on these pixel points, to obtain point cloud data corresponding to these pixel points. These point cloud data may be stored in the SLAM system, so that the estimated depth value of the moving object may be determined through the SLAM system.

In the embodiment, the estimated depth value of the moving object in the to-be-processed video frame with the video processing type of the real-time processing type is determined. On the basis of the embodiment, in a case that the video processing type is the post-processing type, the corresponding target processing mode also changes accordingly, and the post-processing type may be described in detail below.

According to the technical solution in the embodiment of the disclosure, the video processing type is determined: the target processing mode for estimating the depth of the moving object is determined based on the video processing type; and finally, the estimated depth value of the moving object in the to-be-processed video frame is determined based on the target processing mode. Thereby, the problem that the depth information of only the static object can be estimated in the related art is solved, and the effect of accurately estimating the depth information of the moving object in the video frame is realized. Moreover, the application range of depth estimation is expanded, the personalized demands of users are satisfied, and the user experience is improved.

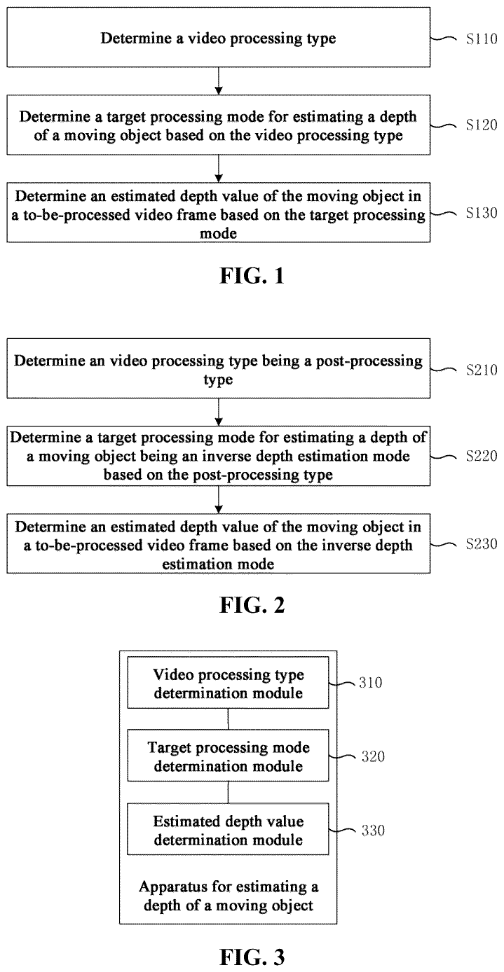

FIG. 2 is a schematic flowchart of another method for estimating a depth of a moving object according to an embodiment of the disclosure. On the basis of the foregoing embodiment, in a case that the video processing type is the post-processing type, the corresponding target processing mode may be an inverse depth estimation mode. An estimated depth value of the moving object may be determined based on the inverse depth estimation mode. Reference may be made to the technical solution in the embodiment for the embodiment of another method. The technical terms identical to or corresponding to those in the above embodiment will not be repeated herein.

As shown in FIG. 2, the method includes the following steps.

At S210, the video processing type is determined as the post-processing type.

In the above embodiment, the estimated depth value of the moving object in the to-be-processed video frame with the video processing type of the real-time processing type is determined. On the basis of the above embodiment, in a case that the video processing type is the post-processing type, the corresponding target processing mode also changes accordingly. The post-processing type may be described below.

In the embodiment, a video upload control may be pre-developed. In a case of detecting that a trigger operation is performed by the user on the video upload control in the application, a video uploaded by the user actively may be received, and taken as the to-be-processed video. The to-be-processed video may be parsed based on a pre-written program, to obtain a plurality of to-be-processed video frames. Correspondingly, the to-be-processed video frames include the moving object. The moving object may be the user, an animal, or any object whose post or position information changes in the frames. When a complete to-be-processed video is received, video frames including the moving object may be taken as the to-be-processed video frames. An effect processing may be performed on these video frames, to obtain corresponding effect video frames. Such a video processing mode may be taken as the post-processing type.

At S220, the target processing mode for estimating the depth of the moving object is determined as an inverse depth estimation mode based on the post-processing type.

In the embodiment, after the to-be-processed video is received, and the video processing type is determined as the post-processing type, the target processing mode for estimating the depth of the moving object in the to-be-processed video frame may be determined as the inverse depth estimation mode. The inverse depth estimation mode may be to determine an estimated depth value of the moving object based on an inverse depth value of at least one pixel point corresponding to the moving object.

In a case that the video processing mode is the post-processing type, in other words, a depth of a moving object in complete video data is estimated, differing from the real-time processing type, after the completed video data are received, depth information of each pixel point in each to-be-processed video frame in the video data may be determined, and depth information of the moving object may be estimated based on the depth information. However, the depth information of different pixel points in each to-be-processed video frame has a large distribution range, and a depth distribution form thereof is unstable. Therefore, inverse depth information corresponding to the depth information may be determined, to determine the estimated depth value of the moving object based on the inverse depth information. Such an arrangement is advantageous in that an inverse depth distribution form better conforms to the Gaussian distribution form, and is thus more stable, so that the estimated depth value of the moving object is determined more accurately.

Each to-be-processed video frame includes distant-range pixel points and close-range pixel points. The distant-range pixel points have a long distance with the capturing point, and thus have small parallax. In a case of determining point cloud data corresponding to these distant-range pixel points, precision of the point cloud data are also low. Therefore, the inverse depth mode may be employed to reduce the influence of the distant-range pixel points on a calculation process. Depth values of the distant-range pixel points and the close-range pixel points are converted into inverse depth values. Subsequent calculation may be performed based on these inverse depth values, so that the effect of improving calculation precision can be reached.

At S230, the estimated depth value of the moving object in the to-be-processed video frame is determined based on the inverse depth estimation mode.

In the embodiment, after the target processing mode is determined as the inverse depth estimation mode, an inverse depth value of each pixel point in the to-be-processed video frame may be determined, so that the estimated depth value of the moving object may be determined based on these inverse depth values.

Determining the estimated depth value of the moving object in the to-be-processed video frame based on the inverse depth estimation mode includes that: triangulation processing is performed on each to-be-processed video frame in a target video, to obtain an inverse depth value of each pixel point in each to-be-processed video frame; and the estimated depth value of the moving object is determined by clustering a plurality of inverse depth values in the same to-be-processed video frame.

In the embodiment, the target video may be a video uploaded by the user actively, and having the depth information of the moving object in the video to be determined. In practical application, in a case of receiving the plurality of to-be-processed video frames in the target video, the triangulation processing may be performed on each to-be-processed video frame based on the corner detection algorithm, to obtain point cloud data corresponding to each to-be-processed video frame. The point cloud data corresponding to each to-be-processed video frame may be converted into the camera coordinate system based on a rotation-translation matrix, to obtain a depth value of each pixel point in the camera coordinate system. Then, inversing process is performed on these depth values, in other words, the inverse depth value of each pixel point may be obtained by determining the negative power of each depth value. Accordingly, the estimated depth value of the moving object may be determined by clustering a plurality of inverse depth values in the same to-be-processed video frame. Such an arrangement is advantageous in that the influence of the distant-range pixel points on the depth estimation can be reduced by estimating the depth of the moving object based on the inverse depth value of each pixel point. Therefore, an accuracy rate of the estimated depth value can be increased, and the display effect of a freeze-frame point of the moving object in the target video under different time stamps can be improved.

The clustering process may be to classify the plurality of inverse depth values, and may indicate binary classification, in other words, the plurality of inverse depth values are divided into two classes.

Determining the estimated depth value of the moving object by clustering the plurality of inverse depth values in the same to-be-processed video frame includes that: based on ranking the plurality of inverse depth values, a depth difference between two adjacent inverse depth values is determined; and two target inverse depth values having a maximum depth difference are acquired, and the estimated depth value of the moving object is determined based on multiple inverse depth values greater than the target inverse depth values.

In practical application, each of the plurality of inverse depth values in the same to-be-processed video frame may be determined first, and the plurality of inverse depth values may be ranked. Then, the difference between two adjacent inverse depth values is determined as the depth difference. Two adjacent inverse depth values corresponding to the maximum depth difference are determined, and taken as the target inverse depth values. The plurality of inverse depth values may be divided into two classes based on the two target inverse depth values, where one class includes the multiple inverse depth values greater than the target inverse depth values, and the other class includes multiple inverse depth values less than the target inverse depth values. Finally, the estimated depth value of the moving object may be determined based on the multiple inverse depth values greater than the target inverse depth values. Such an arrangement is advantageous in that the close-range pixel points and the distant-range pixel points may be classified based on the plurality of inverse depth values, so that the depth information of the moving object may be determined based on depth information of the close-range pixel points.

In the embodiment, since the plurality of inverse depth values are ranked in a descending order, the two target inverse depth values are two adjacent ones of the plurality of inverse depth values. Therefore, in a case that the estimated depth value of the moving object is determined based on the multiple inverse depth values greater than the target inverse depth values, the target inverse depth value used may be any one of the two target inverse depth values, and the effect of classifying the plurality of inverse depth values can be reached.

In a case of classifying the plurality of inverse depth values based on the target inverse depth values, in a case that a number of inverse depth values in any class is less than a preset threshold, it may be deemed that the inverse depth values in the class may have certain errors. In order to increase the accuracy rate of the estimated depth value of the moving object, these inverse depth values may be deleted, and a plurality of remaining inverse depth values may be re-ranked and re-classified. Therefore, after re-classifying is completed, the estimated depth value of the moving object is determined based on multiple inverse depth values greater than the target inverse depth values for the re-classifying result.

In view of the above, before determining the estimated depth value of the moving object based on multiple inverse depth values greater than the target inverse depth values, the method further includes: in response to a ratio between a number of inverse depth values greater than or less than the target inverse depth values and a total number of the inverse depth values being less than a preset ratio, the inverse depth values greater than or less than the target inverse depth values are deleted, and an operation of determining target inverse depth values is re-performed.

In the embodiment, the preset ratio may be any value, and may be 5%.

In practical application, after the plurality of inverse depth values are divided into the multiple inverse depth values greater than the target inverse depth values and multiple inverse depth values less than the target inverse depth values based on the target inverse depth values, the ratio between a number of each of these two classes of inverse depth values and a total number of inverse depth values in a current to-be-processed video frame may be determined. In a case that the ratio corresponding to any class is less than the preset ratio, the inverse depth values in this class may be deleted, and a plurality of remaining inverse depth values are re-ranked. Then, a difference between two adjacent inverse depths is determined. Two inverse depth values having a maximum difference are taken as the target inverse depth values, and the plurality of remaining inverse depth values are classified based on the target inverse depth values. Therefore, the estimated depth value of the moving object may be determined finally based on multiple inverse depth values greater than the target inverse depth values. Such an arrangement is advantageous in that inverse depth values having large errors can be filtered out and deleted, to reach the effect of increasing the accuracy rate of the estimated depth value of the moving object.

Determining the estimated depth value of the moving object based on the multiple inverse depth values greater than the target inverse depth values includes that: averaging processing is performed on the multiple inverse depth values greater than the target inverse depth values, to obtain an inverse depth average value, and the estimated depth value of the moving object is determined based on the inverse depth average value.

After the multiple inverse depth values greater than the target inverse depth values are obtained, since pixel points corresponding to these inverse depth values are the close-range pixel points of the to-be-processed video frame, an accurate calculation result may be obtained when calculation is performed based on the close-range pixel points. Moreover, the moving object is generally positioned in a foreground portion of the to-be-processed video frame. Therefore, in a case of determining the estimated depth value of the moving object, the calculation being performed based on the plurality of inverse depth values greater than the target inverse depth values may achieve a more accurate depth estimation result.

In practical application, the averaging processing may be performed on the multiple inverse depth values greater than the target inverse depth values, and the inverse depth average value obtained may be re-inversed, to obtain a depth average value corresponding to the inverse depth average value. The depth average value may be taken as the estimated depth value of the moving object. Such an arrangement is advantageous in that by determining the depth information of the moving object based on the depth information of the close-range pixel points, the effect of increasing the accuracy rate of depth estimation can be reached.

The estimated depth value of the moving object in any to-be-processed video frame in the target video may be determined through the above technical method. Accordingly, after the estimated depth value of the moving object in each to-be-processed video frame is obtained, the plurality of to-be-processed video frames may be spliced together, to obtain the estimated depth value of the moving object in the complete target video.

According to the technical solution in the embodiment of the disclosure, the video processing type is determined as the post-processing type: the target processing mode for estimating the depth of the moving object is determined as the inverse depth estimation mode based on the post-processing type; and finally; the estimated depth value of the moving object in the to-be-processed video frame is determined based on the inverse depth estimation mode. Thereby, the problem that the depth information of only the static object can be estimated in the related art is solved, and the effect of accurately estimating the depth information of the moving object in the video frame is realized. Moreover, the application range of the depth estimation is expanded, the personalized demands of users are satisfied, and the user experience is improved.

FIG. 3 is a schematic structural diagram of an apparatus for estimating a depth of a moving object according to an embodiment of the disclosure. As shown in FIG. 3, the apparatus includes: a video processing type determination module 310, a target processing mode determination module 320, and an estimated depth value determination module 330.

The video processing type determination module 310 is configured to determine a video processing type. The target processing mode determination module 320 is configured to determine a target processing mode for estimating the depth of the moving object based on the video processing type. The estimated depth value determination module 330 is configured to determine an estimated depth value of the moving object in a to-be-processed video frame based on the target processing mode.

On the basis of the above technical solution, the video processing type includes a real-time processing type and a post-processing type.

On the basis of the above technical solution, the target processing mode includes a depth mean estimation mode corresponding to the real-time processing type or an inverse depth estimation mode corresponding to the post-processing type.

On the basis of the above technical solution, the target processing mode includes the depth mean estimation mode, and the estimated depth value determination module 330 includes a capturing parameter determination sub-module, a target pixel point determination sub-module, and an estimated depth value determination sub-module.

The capturing parameter determination sub-module is configured to determine a capturing parameter corresponding to the to-be-processed video frame and a pixel point parameter of the moving object. The target pixel point determination sub-module is configured to determine a target pixel point based on the capturing parameter, the pixel point parameter, and a constraint condition. The estimated depth value determination sub-module is configured to determine the estimated depth value of the moving object based on point cloud data of the target pixel point.

On the basis of the above technical solution, the target pixel point determination sub-module includes a point cloud data determination unit, a backprojection pixel parameter determination unit, and a target pixel point determination unit.

The point cloud data determination unit is configured to perform triangulation processing on the capturing parameter and the pixel point parameter, to obtain point cloud data corresponding to the pixel point parameter. The backprojection pixel parameter determination unit is configured to determine a backprojection pixel parameter based on the point cloud data and the constraint condition. The target pixel point determination unit is configured to determine the target pixel point based on the pixel point parameter and the backprojection pixel parameter.

On the basis of the above technical solution, the estimated depth value determination sub-module includes a to-be-used video frame determination unit and an estimated depth value determination unit.

The to-be-used video frame determination unit is configured to determine at least two to-be-used video frames to which the target pixel point belongs based on the point cloud data of the target pixel point. The estimated depth value determination unit is configured to determine the estimated depth value of the moving object based on depth values of the target pixel point in the at least two to-be-used video frames.

On the basis of the above technical solution, the target processing mode includes the inverse depth estimation mode, and the estimated depth value determination module 330 further includes an inverse depth value determination sub-module and an estimated depth value determination sub-module.

The inverse depth value determination sub-module is configured to perform triangulation processing on each to-be-processed video frame in a target video, to obtain an inverse depth value of each pixel point in each to-be-processed video frame. The estimated depth value determination sub-module is configured to determine the estimated depth value of the moving object by clustering a plurality of inverse depth values in the same to-be-processed video frame.

On the basis of the above technical solution, the estimated depth value determination sub-module includes a depth difference determination unit and an estimated depth value determination unit.

The depth difference determination unit is configured to determine, based on ranking the plurality of inverse depth values, a depth difference between two adjacent inverse depth values. The estimated depth value determination unit is configured to acquire two target inverse depth values having a maximum depth difference, and determine the estimated depth value of the moving object based on multiple inverse depth values greater than the target inverse depth values.

On the basis of the above technical solution, the apparatus further includes: an inverse depth value deletion module.

Before the estimated depth value of the moving object is determined based on the multiple inverse depth values greater than the target inverse depth values, the inverse depth value deletion module is configured to delete, in a case that a ratio between a number of inverse depth values greater than or less than the target inverse depth values and a total number of the inverse depth values is less than a preset ratio, the inverse depth values greater than or less than the target inverse depth values, and re-perform an operation of determining target inverse depth values.

On the basis of the above technical solution, the estimated depth value determination unit is configured to perform averaging processing on the multiple inverse depth values greater than the target inverse depth values, to obtain an inverse depth average value, and determine the estimated depth value of the moving object based on the inverse depth average value.

According to the technical solution in the embodiment of the disclosure, the video processing type is determined; the target processing mode for estimating the depth of the moving object is determined based on the video processing type; and the estimated depth value of the moving object in the to-be-processed video frame is determined based on the target processing mode. Thereby, the problem that the depth information of only the static object can be estimated in the related art is solved, and the effect of accurately estimating the depth information of the moving object in the video frame is realized. Moreover, the application range of depth estimation is expanded, the personalized demands of users are satisfied, and the user experience is improved.

The apparatus for estimating a depth of a moving object according to the embodiment of the disclosure may execute the method for estimating a depth of a moving object according to any embodiment of the disclosure, has the corresponding function modules for executing the method, and exerts the effect.

The plurality of units and modules included in the above apparatus are divided merely by function logic, but are not limited to the above division, as long as corresponding functions can be implemented. In addition, the names of the plurality of function units are merely for convenience of distinguishing from one another, and are not used to limit the scope of protection in the embodiments of the disclosure.

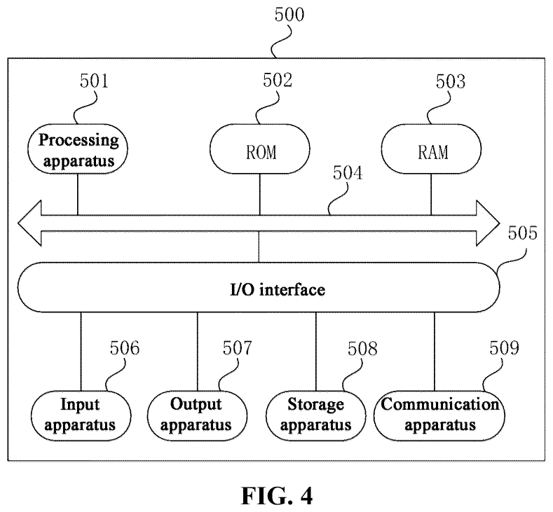

FIG. 4 is a schematic structural diagram of an electronic device according to an embodiment of the disclosure. With reference to FIG. 4 below, a schematic structural diagram of an electronic device 500 (for example, a terminal device or a server in FIG. 4) suitable for implementing the embodiment of the disclosure is shown. The terminal device in the embodiment of the disclosure may include a mobile terminal such as a mobile phone, a notebook computer, a digital broadcast receiver, a personal digital assistant (PDA), a portable android device (PAD), a portable media player (PMP), and an in-vehicle terminal (for example, and an in-vehicle navigation terminal); and a fixed terminal such as a digital television (TV) and a desktop computer. The electronic device 500 shown in FIG. 4 is merely illustrative, and should not limit the functions and use scope in the embodiment of the disclosure in any way.

As shown in FIG. 4, the electronic device 500 may include a processing apparatus 501 (for example, a central processing unit and a graphic processor) that may execute various suitable actions and processing according to a program stored in a read-only memory (ROM) 502 or loaded into a random access memory (RAM) 503 from a storage apparatus 508. The RAM 503 may also store various programs and data required for an operation of the electronic device 500. The processing apparatus 501, the ROM 502, and the RAM 503 are connected to one another through a bus 504. An input/output (I/O) interface 505 is also connected to the bus 504.

Generally, the I/O interface 505 may be connected to apparatuses including: an input apparatus 506 such as a touch screen, a touch pad, a keyboard, a mouse, a camera, a microphone, an accelerometer, and a gyroscope; an output apparatus 507 such as a liquid crystal display (LCD), a speaker, and a vibrator; a storage apparatus 508 such as a magnetic tape and a hard disc; and a communication apparatus 509. The communication apparatus 509 may allow wireless or wired communication between the electronic device 500 and other devices for data exchange. Although FIG. 4 shows the electronic device 500 having various apparatuses, not all the apparatuses shown are required to be implemented or configured. More or fewer apparatuses may be implemented or configured alternatively.

The processes described above with reference to the flowcharts may be implemented as computer software programs according to the embodiment of the disclosure. For example, a computer program product is included in an embodiment of the disclosure. The computer program product includes a computer program carried on a non-transitory computer-readable medium, and the computer program includes a program code configured to execute the method shown in the flowchart. In such an embodiment, the computer program may be downloaded and installed via a network through the communication apparatus 509, installed via the storage apparatus 508, or installed via the ROM 502. The computer program executes the above functions defined in the method in the embodiment of the disclosure when executed by the processing apparatus 501.

The name of a message or information interacting between a plurality of apparatuses in the embodiments of the disclosure is merely descriptive, and is not intended to limit the scope of the message or information.

The electronic device according to the embodiment of the disclosure and the method for estimating a depth of a moving object according to the above embodiment belongs to the same concept, so that reference may be made to the above embodiment for the technical details not described in detail in the embodiment, and the embodiment has the same effect as the above embodiment.

A computer storage medium is provided in an embodiment of the disclosure. The computer storage medium stores a computer program, where when executed by a processor, the computer program implements the method for estimating a depth of a moving object according to the above embodiment.

The above computer-readable medium of the disclosure may be a computer-readable signal medium, a computer-readable storage medium, or any combination of the above. The computer-readable storage medium may be, for example, an electronic, magnetic, optical, electromagnetic, infrared, or semiconductor system, apparatus, or device, or any combinations of the above. Instances of the computer-readable storage medium may include: a portable computer magnetic disc, a hard disc, an RAM, an ROM, an erasable programmable read-only memory (EPROM) or a flash memory, an optical fiber, a portable compact disc read-only memory (CD-ROM), an optical storage device, and a magnetic storage device that are each electrically connected through one or more wires, or any suitable combinations of the above. In the disclosure, the computer-readable storage medium may be any tangible medium that includes or stores a program. The program may be used by or in combination with an instruction execution system, apparatus, or device. In the disclosure, however, the computer-readable signal medium may include a data signal propagated in a baseband or as part of a carrier wave, having a computer-readable program code carried thereon. Such a propagated data signal may take various forms including an electromagnetic signal, an optical signal, or any suitable combinations of the above. The computer-readable signal medium that may also be any computer-readable medium except for the computer-readable storage medium, may transmit, propagate, or transfer a program to be used by or in combination with the instruction execution system, apparatus, or device. The program code included in the computer-readable medium may be transferred via any suitable medium, including a wire, an optic cable, a radio frequency (RF), etc., or any suitable combinations of the above.

In some embodiments, clients and servers can communicate with each other via any network protocol currently known (such as a hypertext transfer protocol (HTTP)) or any network protocol to be developed in the future, and can be interconnected to digital data communication (for example, a communication network) in any form or medium. Instances of the communication network include a local area network (LAN), a wide area network (WAN), the Internet, a peer-to-peer network (for example, an ad hoc peer-to-peer network), and any network currently known or to be developed in the future.

The above computer-readable medium may be included in the above electronic device, or exist alone without being assembled into the electronic device.

The above computer-readable medium carries one or more programs. When executed by the electronic device, the above one or more programs cause the electronic device to determine a video processing type; determine a target processing mode for estimating the depth of the moving object based on the video processing type; and determine an estimated depth value of the moving object in a to-be-processed video frame based on the target processing mode.

The computer program codes configured to execute operations of the disclosure can be written in one or more programming languages or their combinations. The above programming languages include object-oriented programming languages, such as Java. Smalltalk, and C++, and conventional procedural programming languages, such as “C” language. The program code can be executed on a user's computer in all or in part, executed as an independent software package, executed on a user's computer in part and executed on a remote computer in part, or executed on a remote computer or a server in all. In a case involving the remote computer, the remote computer can be connected to the user's computer through any kind of network, including the LAN or the WAN, or can be connected to an external computer (for example, through the Internet by means of an Internet service provider).

The flowcharts and block diagrams in the accompanying drawings illustrate possibly-implementable system architectures, functions, and operations of the system, method, and computer program product according to various embodiments of the disclosure. In this regard, each block in the flowcharts or the block diagrams can indicate a module, a program segment, or a code segment, which includes one or more executable instructions configured to implement specified logic functions. It should also be noted that in some alternative embodiments, the functions noted in the blocks can also occur in an order other than those noted in the accompanying drawings. For example, two blocks represented in succession can in fact be executed substantially in parallel or in a reverse order sometimes, depending on the functions involved. It should also be noted that each block in the block diagrams and/or the flowcharts and combinations of blocks in the block diagrams and/or the flowcharts can be implemented through specific hardware-based systems that execute the specified functions or operations, or combinations of specific hardware and computer instructions.

The unit involved in the embodiment of the disclosure can be implemented through software or hardware. The name of the unit is not intended to define the unit itself under one circumstance. For example, a first acquisition unit can also be described as “a unit that acquires at least two Internet protocol addresses.

At least part of the above functions can be executed by one or more hardware logic components herein. For example, non-restrictively, illustrative types of usable hardware logic components include: a field programmable gate array (FPGA), an application specific integrated circuit (ASIC), application specific standard parts (ASSPs), a system on chip (SOC), a complex programmable logic device (CPLD), etc.

In the context of the disclosure, a machine-readable medium can be a tangible medium that can include or store a program to be used by or in combination with the instruction execution system, apparatus, or device. The machine-readable medium can be a machine-readable signal medium or a machine-readable storage medium. The machine-readable medium can include an electronic, magnetic, optical, electromagnetic, infrared, or semiconductor system, apparatus, or device, or any suitable combinations of the above. Instances of the machine-readable storage medium include a portable computer disc, a hard disc, an RAM, an ROM, an EPROM or a flash memory, an optical fiber, a CD-ROM, an optical storage device, and a magnetic storage device that are each electrically connected through one or more wires, or any suitable combinations of the above.

In addition, a plurality of operations are depicted in a specific order. However, it should not be understood that these operations are required to be executed in the specific order shown or in a successive order. Under certain circumstances, multitasking and parallel processing may be advantageous. Similarly, a plurality of implementation details are included in the above discussion, but should not be interpreted as limiting the scope of the disclosure. Some features that are described in the context of separate embodiments can also be implemented jointly in a single embodiment. Likewise, a plurality of features that are described in the context of a single embodiment can also be implemented in a plurality of embodiments separately or in any suitable sub-combination manner.

1. A method for estimating a depth of a moving object, comprising:
determining a video processing type;
determining a target processing mode for estimating the depth of the moving object based on the video processing type; and
determining an estimated depth value of the moving object in a to-be-processed video frame based on the target processing mode.

2. The method according to claim 1, wherein the video processing type comprises a real-time processing type and a post-processing type.

3. The method according to claim 2, wherein the target processing mode comprises a depth mean estimation mode corresponding to the real-time processing type or an inverse depth estimation mode corresponding to the post-processing type.

4. The method according to claim 1, wherein the target processing mode comprises a depth mean estimation mode, and wherein determining the estimated depth value of the moving object in the to-be-processed video frame based on the target processing mode comprises:
determining a capturing parameter corresponding to the to-be-processed video frame and a pixel point parameter of the moving object;
determining a target pixel point based on the capturing parameter, the pixel point parameter, and a constraint condition; and
determining the estimated depth value of the moving object based on point cloud data of the target pixel point.

5. The method according to claim 4, wherein determining the target pixel point based on the capturing parameter, the pixel point parameter, and the constraint condition comprises:
performing triangulation processing on the capturing parameter and the pixel point parameter, to obtain the point cloud data corresponding to the pixel point parameter;
determining a backprojection pixel parameter based on the point cloud data and the constraint condition; and
determining the target pixel point based on the pixel point parameter and the backprojection pixel parameter.

6. The method according to claim 4, wherein determining the estimated depth value of the moving object based on point cloud data of the target pixel point comprises:
determining at least two to-be-used video frames to which the target pixel point belongs based on the point cloud data of the target pixel point; and
determining the estimated depth value of the moving object based on depth values of the target pixel point in the at least two to-be-used video frames.

7. The method according to claim 1, wherein the target processing mode comprises an inverse depth estimation mode, and wherein determining the estimated depth value of the moving object in the to-be-processed video frame based on the target processing mode comprises:
performing triangulation processing on each to-be-processed video frame in a target video, to obtain an inverse depth value of each pixel point in each to-be-processed video frame; and
determining the estimated depth value of the moving object by clustering a plurality of inverse depth values in a same to-be-processed video frame.

8. The method according to claim 7, wherein determining the estimated depth value of the moving object by clustering the plurality of inverse depth values in the same to-be-processed video frame comprises:
determining, based on ranking the plurality of inverse depth values, a depth difference between two adjacent inverse depth values; and
acquiring two target inverse depth values having a maximum depth difference, and determining the estimated depth value of the moving object based on multiple inverse depth values greater than the target inverse depth values.

9. The method according to claim 8, wherein before determining the estimated depth value of the moving object based on the multiple inverse depth values greater than the target inverse depth values, the method further comprises:
in response to a ratio between a number of inverse depth values greater than or less than the target inverse depth values and a total number of the inverse depth values being less than a preset ratio, deleting the inverse depth values greater than or less than the target inverse depth values, and re-performing an operation of determining target inverse depth values.

10. The method according to claim 8, wherein determining the estimated depth value of the moving object based on the multiple inverse depth values greater than the target inverse depth values comprises:
performing averaging processing on the multiple inverse depth values greater than the target inverse depth values, to obtain an inverse depth average value, and determining the estimated depth value of the moving object based on the inverse depth average value.

11. (canceled)

12. An electronic device, comprising:
at least one processor; and
a storage apparatus configured to store at least one program which, when executed by the at least one processor, configures the at least one processor to:
determine a video processing type;
determine a target processing mode for estimating a depth of a moving object based on the video processing type; and
determine an estimated depth value of the moving object in a to-be-processed video frame based on the target processing mode.

13. (canceled)

14. A computer program product comprising a computer program carried on a non-transitory computer-readable medium, wherein the computer program comprises a program code configured to:
determine a video processing type;
determine a target processing mode for estimating a depth of a moving object based on the video processing type; and
determine an estimated depth value of the moving object in a to-be-processed video frame based on the target processing mode.

15. The electronic device according to claim 12, wherein the video processing type comprises a real-time processing type and a post-processing type.

16. The electronic device according to claim 15, wherein the target processing mode comprises a depth mean estimation mode corresponding to the real-time processing type or an inverse depth estimation mode corresponding to the post-processing type.

17. The electronic device according to claim 12, wherein the target processing mode comprises a depth mean estimation mode, and wherein, to determine the estimated depth value of the moving object in the to-be-processed video frame based on the target processing mode, the at least one processor is configured to:
determine a capturing parameter corresponding to the to-be-processed video frame and a pixel point parameter of the moving object;
determine a target pixel point based on the capturing parameter, the pixel point parameter, and a constraint condition; and
determine the estimated depth value of the moving object based on point cloud data of the target pixel point.

18. The electronic device according to claim 17, wherein, to determine the target pixel point based on the capturing parameter, the pixel point parameter, and the constraint condition, the at least one processor is configured to:
perform triangulation processing on the capturing parameter and the pixel point parameter, to obtain the point cloud data corresponding to the pixel point parameter;
determine a backprojection pixel parameter based on the point cloud data and the constraint condition; and
determine the target pixel point based on the pixel point parameter and the backprojection pixel parameter.

19. The electronic device according to claim 17, wherein, to determine the estimated depth value of the moving object based on point cloud data of the target pixel point, the at least one processor is configured to:
determine at least two to-be-used video frames to which the target pixel point belongs based on the point cloud data of the target pixel point; and
determine the estimated depth value of the moving object based on depth values of the target pixel point in the at least two to-be-used video frames.

20. The electronic device according to claim 12, wherein the target processing mode comprises an inverse depth estimation mode, and wherein, to determine the estimated depth value of the moving object in the to-be-processed video frame based on the target processing mode, the at least one processor is configured to:
perform triangulation processing on each to-be-processed video frame in a target video, to obtain an inverse depth value of each pixel point in each to-be-processed video frame; and
determine the estimated depth value of the moving object by clustering a plurality of inverse depth values in a same to-be-processed video frame.

21. The electronic device according to claim 20, wherein, to determine the estimated depth value of the moving object by clustering the plurality of inverse depth values in the same to-be-processed video frame, the at least one processor is configured to:
determine, based on ranking the plurality of inverse depth values, a depth difference between two adjacent inverse depth values; and
acquire two target inverse depth values having a maximum depth difference, and determine the estimated depth value of the moving object based on multiple inverse depth values greater than the target inverse depth values.

22. The electronic device according to claim 21, wherein before determining the estimated depth value of the moving object based on the multiple inverse depth values greater than the target inverse depth values, the at least one processor is further configured to:
in response to a ratio between a number of inverse depth values greater than or less than the target inverse depth values and a total number of the inverse depth values being less than a preset ratio, delete the inverse depth values greater than or less than the target inverse depth values, and re-perform an operation of determining target inverse depth values.
